(19) United States
(12) Patent Application Publication
(10) Pub. No.: US 2024/0351327 A1
(43) Pub. Date: Oct. 24, 2024

(54) PIN OVEN FOR PRODUCING CONTAINERS, AND METHOD

(71) Applicant: BELVAC PRODUCTION MACHINERY, INC., Lynchburg, VA (US)

(72) Inventors: Ulf REINHARDT, Teutschenthal (DE); Wilko HARMS, Wittmund (DE)

(21) Appl. No.: 18/684,167

(22) PCT Filed: Aug. 5, 2022
(86) PCT No.: PCT/DE2022/100569

§ 371 Date: Feb. 15, 2024

(30) Foreign Application Priority Data
Aug. 19, 2021 (DE) 10 2021 121 521.8

(51) Int. Cl. B41F 23/04; F26B 15/12; F26B 25/02

(52) U.S. Cl. CPC B41F 23/04; F26B 15/128; F26B 25/02

(57) ABSTRACT

The invention relates to a pin oven for producing containers, comprising a drying chamber for drying the containers using a temperature-controlled process fluid, at least one axle for supporting a bearing element arranged inside the drying chamber, and at least one axle bearing arranged outside the drying chamber, the axle being supported by the axle bearing, and the axle bearing being arranged in a heat-insulating fashion relative to the surroundings of the pin oven.

### CROSS-REFERENCE TO RELATED APPLICATIONS

This application is a U.S. national stage of International Application No. PCT/DE2022/100569, filed Aug. 5, 2022, which claims the benefit of and priority to German Patent Application No. 10 2021 121 521.8, filed Aug. 19, 2021, each of which are hereby incorporated by reference herein in its entirety.

### FIELD

The invention relates to a pin oven for producing containers and a method for producing a pin oven and for increasing the energy efficiency of a pin oven.

### BACKGROUND

Pin ovens are generally known. Containers, such as cans for drinks, usually have a finish on the outer surface, which is designed as a coating of lacquer or paint. Such a finish can, for example, display the brand name of the provider, instructions for use, or other content.

In addition, the inner surfaces of the cans are usually coated in a process step after the pin oven and then dried in a corresponding continuous oven, also known as an internal baking oven. Coatings are also used that affect the producing process of the can. For example, the cans are provided with such a coating on the underside of the can in order to adjust the sliding properties of the cans on the various conveyor belts.

A device for applying such a coating to container units is also known as a printing device or decorator. To ensure that this coating remains durable, it must be cured after application. For this curing of the coating, pin ovens are used in which the coating is convectively heated, dried, and/or cured.

The cans are conveyed in a meandering pattern with a pin chain through a drying chamber of the pin oven. In the meantime, these are exposed to a temperature-controlled fluid flow to heat, dry, and harden the coating. For example, the cans are heated to 180° C. and exposed to this temperature for a defined period of time. In addition, the cans are subjected to a further fluid flow in order to position the cans on the pin chain. The pin chain and other components of the pin oven require the use of axles inside the drying chamber.

Axles are known to be supported by bearings, for example roller bearings. It is possible to arrange the bearings inside the drying chamber or outside the drying chamber. Arrangement of the bearings inside the drying chamber means that they are difficult to reach in the event of damage. In addition, it is more difficult to change or maintain the bearing.

A bearing arranged outside the drying chamber means that heat is transported between the drying chamber and the surroundings via the axles, so that an energy loss via the axles must always be taken into account. It is a worldwide design standard for pin ovens to arrange the bearings outside the drying chamber and to accept the energy loss via the axles.

One disadvantage of existing pin ovens is that their energy consumption is high. The fans used are characterized in particular by their high power consumption. In addition, a heating unit, such as a gas bumer or an electric heating coil, is used to heat the process fluid in the oven chamber, which also requires energy. In order to meet increasing ecological requirements and sustainability criteria, the energy consumption of pin ovens must be reduced.

It is therefore a task of the invention to provide a pin oven for producing containers and methods for producing a pin oven and for increasing the energy efficiency of a pin oven, which reduce or eliminate one or more of the disadvantages mentioned. In particular, it is a task of the invention to provide a solution that reduces the energy consumption of pin ovens.

This problem is solved with a pin oven and method according to the features of the independent patent claims. Further advantageous embodiments of these aspects are indicated in the respective dependent patent claims. The features listed individually in the patent claims and in the description can be combined with one another in any technologically meaningful way, wherein further embodiments of the invention are shown.

### SUMMARY

According to one embodiment, a pin oven for producing containers is disclosed. The pin oven comprises a drying chamber for drying the containers with a temperature-controlled process fluid. The pin oven further comprises at least one axle for supporting a bearing element arranged inside the drying chamber. The pin oven further comprises at least one axle bearing arranged outside the drying chamber, with which the axle is supported. The axle bearing is arranged in a heat-insulating fashion relative to the surroundings of the pin oven.

According to another embodiment, a method for producing a pin oven is disclosed. The method comprising a drying chamber for drying the containers with a temperature-controlled process fluid and at least one axle for supporting a support element arranged inside the drying chamber. The method comprises arranging an axle bearing outside the drying chamber for supporting the axle. The method further comprises thermally insulating the axle bearing relative to the surroundings of the pin oven.

According to another embodiment, a method for increasing the energy efficiency of a pin oven is disclosed. The pin oven comprises a drying chamber for drying the containers with a temperature-controlled process fluid, at least one axle for supporting a support element arranged inside the drying chamber, and a stock bearing with which the axle is supported. The method comprises replacing the stock bearing by removing the stock bearing and arranging an axle bearing to support the axle. The method further comprises arranging a cover element with a cavity in such a way that the axle bearing is arranged in a heat-insulating fashion relative to the surroundings.

### BRIEF DESCRIPTION OF THE DRAWINGS

Preferred exemplary embodiments are explained by way of example with reference to the enclosed figures. It shows:

FIG. 1: a schematic, two-dimensional view of an exemplary embodiment of a pin oven;

FIG. 2: a schematic view of a method for producing a pin oven; and

FIG. 3: a schematic view of a method for increasing the energy efficiency of a pin oven.

In the figures, identical or essentially functionally identical or similar elements are marked with the same reference symbols.

### DETAILED DESCRIPTION

According to a first aspect, the problem is solved by a pin oven for producing containers, in particular cans, preferably beverage cans, for example from or with steel or aluminum, comprising a drying chamber for drying the containers with a temperature-controlled process fluid, at least one axle for supporting a supporting element arranged inside the drying chamber, at least one axle bearing arranged outside the drying chamber, with which the axle is supported, and the axle bearing being arranged in a heat-insulating fashion relative to the surroundings of the pin oven.

The invention is based on the realization that external axle bearings increase the energy consumption of pin ovens. The increased energy consumption is caused, among other things, by the fact that the axle conducts heat from the drying chamber to the axle bearing, wherein the heat is released from the axle bearing into the surroundings. The increased energy consumption can also be caused by a fluid flow from the drying chamber along the axle to the axle bearing. The invention was also based on the realization that this increased energy consumption can be avoided by an axle bearing that is arranged in a heat-insulating fashion relative to the surroundings of the pin oven.

The drying chamber is designed to dry the containers with a temperature-controlled process fluid. The drying chamber usually has a container inlet, through which the containers can enter the drying chamber, and a container outlet, through which the containers exit the drying chamber. In particular, the pin oven has a pin chain. The containers are usually moved between the container inlet and the container outlet by means of the meandering pin chain. The pin chain has pins on which the containers can be positioned with their interior. In order to heat the containers to a process temperature, for example 180° C., and to keep them at the process temperature for a predetermined period of time, the containers are charged with the temperature-controlled process fluid.

The pin oven has at least one axle for supporting a storage element arranged inside the drying chamber. In particular, the pin oven has two or more, especially a plurality, of axles. The bearing element is any element inside the drying chamber that can be arranged on an axle, is arranged and/or is mechanically coupled to it. The bearing element can, for example, be part of a chain guide, such as a deflection roller.

In addition, the pin oven has at least one axle bearing. The axle bearing is arranged outside the drying chamber. Arranged outside the drying chamber means in particular that the axle bearing is arranged adjacent to the drying chamber. Furthermore, this can mean that the axle bearing is in an essentially direct thermal active connection to the surroundings without thermal insulation. In particular, outside the drying chamber does not mean that the axle bearing is fluidically decoupled from the drying chamber.

The axle bearing is in particular a pivot bearing, for example a roller bearing, in particular a ball or roller bearing. As defined further below, the axle bearing is to be designed in particular as a high-temperature bearing, as the axle bearing is preferably not arranged in a heat-insulating fashion relative to the drying chamber. The axle is supported by the axle bearing.

In addition, it is provided that the axle bearing is arranged in a heat-insulating fashion relative to the surroundings of the pin oven. The area surrounding the pin oven can be a production hall, for example. In particular, the axle bearing is arranged inside a bearing area adjacent to the drying chamber, the bearing area being arranged in a heat-insulating fashion relative to the surroundings of the pin oven.

In particular, the axle bearing is arranged in a heat-insulating fashion relative to the surroundings of the pin oven in such a way that no fluid flows from the drying chamber into the surroundings of the pin oven. It is obvious for the person skilled in the art that a small proportion of the fluid flow can escape into the surroundings through certain leaks. This also comprises the provision of small fluid flows from the drying chamber to the surroundings of the pin oven.

It is preferred that the axle has a seal between the axle bearing and the drying chamber. With such a seal, a fluid flow between the drying chamber and the axle bearing is reduced or avoided.

A thermally insulated arrangement of the axle bearing means in particular that the heat exchange between the drying chamber and the surroundings of the pin oven is reduced by more than 20%, more than 30%, more than 40%, more than 50%, more than 60%, more than 70%, more than 80%, in particular more than 90%. The thermally insulated arrangement of the axle bearing can also be characterized by the fact that essentially no fluid flow flows from the drying chamber into the surroundings of the pin oven.

A preferred embodiment of the pin oven comprises a bearing chamber arranged adjacent to the drying chamber, into which the axle protrudes and within which the axle bearing is arranged, the bearing chamber being arranged in a heat-insulating fashion, in particular fluid-tight, relative to the surroundings. The bearing chamber can protrude into and/or out of the pin oven. A chamber wall is preferably provided between the bearing chamber and the drying chamber, through which the axle extends. This can be realized, for example, by an opening in the chamber wall. It is also preferred that the chamber wall has the axle bearing and/or the bearing chamber. It is furthermore preferred that the bearing chamber is arranged in a heat-insulating fashion.

A preferred embodiment of the pin oven is characterized by the fact that it comprises a connecting space extending between the drying chamber and the bearing chamber, through which the axle extends.

The connecting space can be provided, for example, in the chamber wall mentioned above. Orthogonal to the main direction of extension of the axle, the connecting space preferably has dimensions that are slightly larger than an axle diameter of the axle. It is preferred that the connecting space is less than 1.5 times, less than 1.3 times, and/or less than 1.1 times the diameter of the axle.

In a further preferred embodiment, it is provided that the bearing chamber has an operating opening and the operating opening is closed off by means of a closure element. The bearing chamber can, for example, be concave on the pin oven in such a way that the bearing chamber has the operating opening towards the surroundings. It is also preferred that the closure element is plate-shaped. It is also preferable that the closure element is detachable and/or removable.

A further preferred design of the pin oven is characterized by the fact that the bearing chamber is formed by or comprises a chamber wall. The chamber wall can be box-shaped, for example. Furthermore, it is preferred that the connecting space is provided adjacent to the chamber wall.

A further preferred embodiment of the pin oven comprises an inner wall facing the drying chamber and an outer wall facing away from the drying chamber, the bearing chamber being arranged inside an interspace between the inner wall and the outer wall. The outer wall can be provided in sections, in particular in a section of the pin oven in which the bearing chamber is arranged. The fact that the bearing chamber is arranged inside the interspace means in particular that the bearing chamber is arranged at least in sections inside the interspace. Furthermore, it is preferred that the section of the interspace in which the bearing chamber is not arranged has an insulating material.

A further preferred design variant of the pin oven is characterized by the fact that the drying chamber has a curvature to form the bearing chamber and the axle bearing is arranged inside the curvature. A bearing chamber designed in this way is particularly space-saving.

In a further preferred embodiment of the pin oven, it is provided that the bearing chamber is formed by a cover element with a cavity. The cavity is accessible from at least one side of the cover element. In particular, this side faces the drying chamber so that the axle bearing is accommodated in the cavity.

It is preferred that the cover element is shell-shaped and/or hood-shaped, so that the shell-shaped and/or hood-shaped cover element covers the axle bearing and thus the axle bearing is arranged in a heat-insulating fashion relative to the surroundings of the pin oven. The cover element can also be box-shaped.

The cover element with the cavity has the advantage that the axle bearing, which is arranged in a heat-insulating fashion relative to the surroundings of the pin oven, can be retrofitted.

It is particularly preferred that the cover element is detachable, especially removable. Such a cover element enables the axle bearing to be replaced and maintenance to be carried out.

It is also preferred that the pin oven comprises a fluid channel fluidically coupled to the bearing chamber to provide a pressurized fluid in order to reduce or prevent the process fluid from escaping from the drying chamber into the bearing chamber.

The fluid channel can be used to create a back pressure inside the bearing chamber, which prevents the process fluid from entering the bearing chamber from the drying chamber. The fluid channel can, for example, be coupled to one of the fans enclosed by the pin oven so that the pressurized fluid can be provided.

Another preferred design variant of the pin oven is characterized by the fact that the axle bearing is a high-temperature bearing. A high-temperature bearing is known to the person skilled in the art as a bearing that is used in an ambient temperature that is higher than room temperature. For example, high-temperature bearings can be used in surroundings that reach temperatures of up to 350° C. during operation.

In addition, the high-temperature bearing is preferably lubrication-free. Furthermore, it is preferred that the high-temperature bearing is lubricated for life. It is also preferred that the high-temperature bearing is graphite-lubricated.

According to a further aspect, the task mentioned at the beginning is solved by a method for producing a pin oven, comprising a drying chamber for drying the containers with a temperature-controlled process fluid, at least one axle for supporting a support element arranged inside the drying chamber, comprising the steps: Arrangement of an axle bearing outside the drying chamber to support the axle and thermal insulation of the axle bearing relative to the surroundings of the pin oven.

The axle bearing is arranged in particular in such a way that the axle is supported by the axle bearing. It is also preferable that the axle is sealed between the axle bearing and the drying chamber.

It is further preferred that the thermal insulation step comprises: Arrangement of the axle bearing inside a bearing chamber and thermal insulation of the bearing chamber relative to the surroundings. The thermal insulation of the bearing chamber relative to the surroundings can be achieved with a closure element, for example. In addition, thermal insulation can be provided by a chamber wall of the bearing chamber.

The arrangement of the axle bearing inside a bearing chamber can also mean that the bearing chamber is designed as a cover element with a cavity, in particular a shell-shaped, hood-shaped, and/or box-shaped cover element, and the axle bearing is accommodated in the cavity and/or is covered by the cover element. It is also preferable that the bearing chamber is closed off from the surroundings by the closure element.

According to a further aspect, the task mentioned at the beginning is solved by a method for increasing the energy efficiency of a pin oven, comprising a drying chamber for drying the containers with a temperature-controlled process fluid, at least one axle for supporting a bearing element arranged inside the drying chamber and a stock bearing, with which the axle is supported, comprising the steps: Replacing the stock bearing by removing the stock bearing and arranging an axle bearing to support the axle and arranging a cover element with a cavity in such a way that the axle bearing is arranged in a heat-insulating fashion relative to the surroundings.

In particular, the axle bearing is accommodated in the cavity and/or covered by the cover element. In particular, the axle bearing is a high-temperature bearing. In particular, the axle bearing is arranged in the same position as the stock bearing. It may also be preferable for the axle to be extended.

Using this method to increase energy efficiency, pin ovens can be retrofitted with a thermally insulated axle bearing. This retrofitting is particularly suitable for existing external stock bearings. This means that the energy efficiency of pin ovens already in operation can be improved.

The methods and their possible further development have features or method steps that make them particularly suitable for use with the pin oven and its further development.

For further advantages, design variants, and design details of the other aspects and their possible embodiments, reference is also made to the previous description of the corresponding features and embodiments of the pin oven.

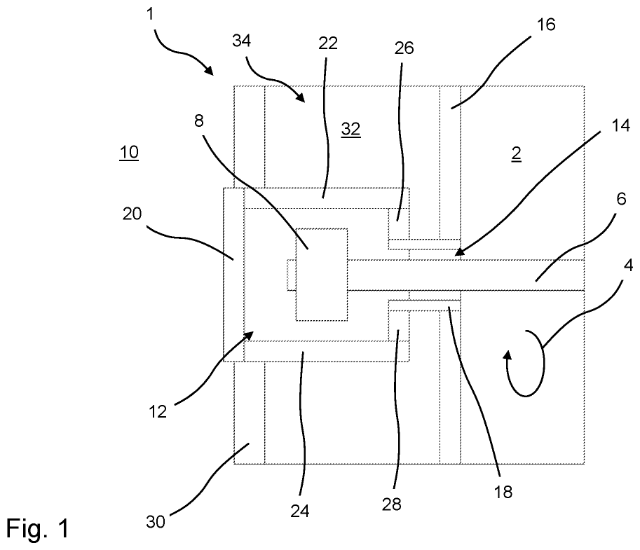

FIG. 1 shows a pin oven 1 for producing containers, in particular cans, for example beverage cans. The pin oven 1 comprises a drying chamber 2 for drying the containers with a temperature-controlled process fluid 4, which is shown schematically.

The pin oven 1 comprises an axle 6 for supporting a storage element arranged inside the drying chamber 2. The bearing element can, for example, be a deflection roller for a pin chain inside the drying chamber 2.

In addition, the pin oven 1 comprises an axle bearing 8 arranged outside the drying chamber 2, with which the axle 6 is supported. The axle bearing 8 is arranged in a heat-insulating fashion relative to the surroundings 10 of the pin oven 1, so that the heat transfer from the drying chamber 2 to the surroundings is reduced. Furthermore, the thermally insulated axle bearing means that no fluid flow 4 flows from the drying chamber 2 into the surroundings 10 of the pin oven 1.

This provides an external axle bearing 8 that is easily accessible for maintenance purposes or for replacing the axle bearing. In addition, the axle bearing 8 is arranged in a heat-insulating fashion relative to the surroundings 10 so that the energy efficiency of the pin oven 1 is increased. As a result, the arrangement of the axle bearing 8 shown in FIG. 1 makes it possible to combine the advantages of an external and an intemal bearing.

The drying chamber 2 is surrounded by a vertical inner wall 16. A connecting space 14 leads through the vertical inner wall 16. The connecting space 14 is formed, among other things, by a horizontal inner wall 18. The axle 6 extends through the connecting space 14.

The axle bearing 8 is arranged in a bearing chamber 12. The bearing chamber 12 is arranged adjacent to the drying chamber 2. The bearing chamber 12 is formed by chamber wall elements 22-28. The bearing chamber 12 is also covered by a closure element 20, which can also be a chamber wall element. The axle bearing 8 is thus arranged inside a bearing chamber 12 that is arranged in a heat-insulating fashion relative to the surroundings 10.

The pin oven 1 also comprises an outer wall 30, which is arranged facing away from the drying chamber 2. An interspace 32 is formed between the inner wall 16 and the outer wall 30, with the bearing chamber 12 being arranged at least partially inside the interspace 32. Insulation 34 is provided inside the remaining interspace 32 to further insulate the drying chamber 2 from the surroundings 10.

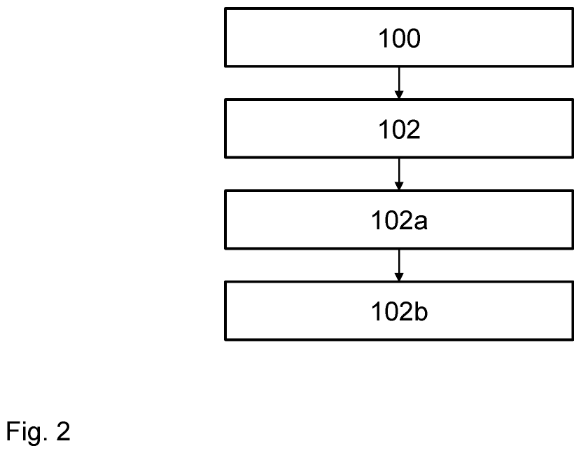

FIG. 2 shows a schematic view of a method for producing a pin oven 1. In step 100, the axle bearing 8 is arranged outside the drying chamber 2 to support the axle 6. In step 102, the axle bearing 8 is arranged in a heat-insulating fashion relative to the surroundings 10 of the pin oven 1. In particular, this is done in such a way that no fluid flow can flow from the drying chamber 2 into the surroundings 10 of the pin oven 1. The thermal insulation 102 comprises the lower step 102a, in which the axle bearing 8 is arranged inside a bearing chamber 12 and the bearing chamber is arranged in a heat-insulating fashion relative to the surroundings. The thermal insulation may further comprise the sub-step 102b, in which the bearing chamber is arranged in a heat-insulating fashion relative to the surroundings with a closure element 20.

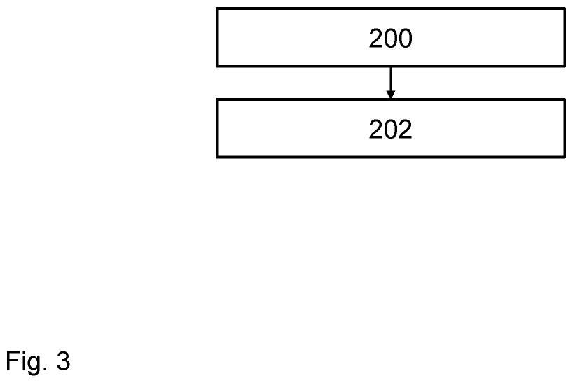

FIG. 3 shows a schematic method for increasing the energy efficiency of a pin oven 1. In step 200, a stock bearing is replaced by removing the stock bearing and arranging an axle bearing 8 to support the axle 6. In step 202, a cover element, for example in the form of a shell or hood, is arranged in such a way that the axle bearing 8 is arranged in a heat-insulating fashion relative to the surroundings 10.

The pin oven 1 mentioned above and the corresponding methods enable an energy-efficient pin oven 1. These advantages are realized by combining the advantages of an internal and external arrangement of the axle bearing 8.

In the past, the special boundary conditions in can production and in particular the high temperatures prevailing there meant that existing approaches for insulating axle bearings 8 could not be used. The pin oven 1 is thus characterized by a high energy efficiency, wherein the axle bearings 8 nevertheless have good interchangeability and/or good maintainability.

### REFERENCE SYMBOLS

1 Pin oven
2 Drying chamber
4 Process fluid
6 Axle
8 Axle bearing
Surroundings
12 Bearing chamber
14 Connecting space
16 Vertical inner wall
18 Horizontal inner wall
20 Closure element
22-28 Chamber wall elements
30 Outer wall
32 Interspace
34 Isolation

1. A pin oven for producing containers, the pin oven comprising:
a drying chamber for drying the containers with a temperature-controlled process fluid;
at least one axle for supporting a bearing element arranged inside the drying chamber; and
at least one axle bearing arranged outside the drying chamber, with which the axle is supported,
wherein the axle bearing is arranged in a heat-insulating fashion relative to the surroundings of the pin oven.

2. The pin oven according to claim 1, comprising a bearing chamber arranged adjacent to the drying chamber and into which the axle protrudes and inside which the axle bearing is arranged, the bearing chamber being designed to be arranged in a heat-insulating fashion, in particular fluid-tight, relative to the surroundings.

3. The pin oven according to claim 1, further comprising a connecting space extending between the drying chamber and the bearing chamber, through which the axle extends.

4. The pin oven according to claim 1, wherein the bearing chamber has an operating opening and the operating opening is closed off by means of a closure element.

5. The pin oven according to claim 1, wherein the bearing chamber is formed by or comprises a chamber wall.

6. The pin oven according to claim 1, further comprising an inner wall facing the drying chamber and an outer wall facing away from the drying chamber, wherein the bearing chamber is arranged inside an interspace between the inner wall and the outer wall.

7. The pin oven according to claim 1, wherein the drying chamber has a curvature to form the bearing chamber and the axle bearing is arranged inside the curvature.

8. The pin oven according to claim 1, wherein the bearing chamber is formed by a cover element with a cavity.

9. The pin oven according to claim 1, further comprising a fluid channel fluidically coupled to the bearing chamber for providing a pressurized fluid to reduce or prevent an escape of the process fluid from the drying chamber into the bearing chamber.

10. The pin oven according to claim 1, wherein the axle bearing is a high-temperature bearing.

11. A method for producing a pin oven, the method comprising a drying chamber for drying the containers with a temperature-controlled process fluid and at least one axle for supporting a support element arranged inside the drying chamber, the method comprising:
arranging an axle bearing outside the drying chamber for supporting the axle; and
thermally insulating the axle bearing relative to the surroundings of the pin oven.

12. The method according to claim 11, wherein the heat insulation comprises arranging the axle bearing inside a bearing chamber and thermally insulating the bearing chamber relative to the surroundings.

13. The method according to claim 12, wherein the bearing chamber is closed off to the surroundings by means of a closure element.

14. The method for increasing the energy efficiency of a pin oven, the pin oven comprising a drying chamber for drying the containers with a temperature-controlled process fluid, at least one axle for supporting a support element arranged inside the drying chamber, and a stock bearing with which the axle is supported, the method comprising:
replacing the stock bearing by removing the stock bearing and arranging an axle bearing to support the axle; and
arranging a cover element with a cavity in such a way that the axle bearing is arranged in a heat-insulating fashion relative to the surroundings.
